(19) United States
(12) Patent Application Publication
(10) Pub. No.: US 2012/0167035 A1
(43) Pub. Date: Jun. 28, 2012

(54) APPARATUS AND METHOD FOR DEVELOPING CUSTOMER-ORIENTED EMOTIONAL HOME APPLICATION SERVICE

(75) Inventors: Mi-Kyong HAN, Daejeon (KR); Hyun-Chul KANG, Daejeon (KR); Eun-Jin KO, Daejeon (KR); Jong-Hyun JANG, Daejeon (KR)

(73) Assignee: ELECTRONICS AND TELECOMMUNICATIONS RESEARCH INSTITUTE, Daejeon (KR)

(21) Appl. No.: 13/329,848

(22) Filed: Dec. 19, 2011

(30) Foreign Application Priority Data
Dec. 22, 2010 (KR) 10-2010-0132478
Jun. 23, 2011 (KR) 10-2011-0061337

(51) Int. Cl. G06F 9/44

(52) U.S. Cl. 717/104

(57) ABSTRACT

An apparatus for developing a user-oriented emotional home application service includes: an emotional information collection unit configured to sense a user and a user's surrounding environment through a sensor and collect one or more pieces of emotional information; an emotional home application service platform engine configured to extract contents suitable for the user based on the collected emotional information; and an application service development support unit configured to support various tools including a service modeling tool for developing an emotional home application service.

### CROSS-REFERENCES TO RELATED APPLICATIONS

The present application claims priority of Korean Patent Application Nos. 10-2010-0132478 and 10-2011-0061337, filed on Dec. 22, 2010, and Jun. 23, 2011, respectively, which are incorporated herein by reference in their entirety.

### BACKGROUND OF THE INVENTION

1. Field of the Invention

Exemplary embodiments of the present invention relate to an apparatus and method for developing a user-oriented emotional home application service; and, more particularly, to an apparatus and method for supporting the development of a user-oriented emotional home application service through a platform for developing a user-oriented emotional hole application service.

2. Description of Related Art

Recently, as customer satisfaction is considered to be important in product performance for differentiating information technology (IT) development, much attention has been paid to emotional marketing based on primary emotions for human beings.

The emotional marketing is to strengthen the ties between a brand and customers through emotional motives having an effect upon the customers' feelings and emotions. The utilization of emotion is a core method capable of differentiating the brand image and strengthen the brand loyalty. That is, the emotional marketing which is a marketing method using the five senses (the sight, the hearing, the touch, the taste, and the smell) is to embody invisible emotions or tastes into colors, forms, and materials or draw unconscious reactions from customers by appealing to the senses or emotions of human beings.

According to such a trend of the emotion marketing, sensory feelings as surrounding environment information for user autonomous reactive services and the emotions of human beings have been fused to satisfy the necessity of a new home service space through mutual exchange in a current digital convergence environment. For the new home service space, research has been conducted on the evolution from a digital home to a green home and an emotional home.

The emotion processing technology related to the emotional home is to give a computer the intelligence to recognize a human emotion and process the human emotion suitably for each condition according to the feedback of an emotion signal. Ultimately, the emotion processing technology is aimed at an efficient interaction between a human and a computer. The emotion processing technology may be divided into an emotion recognition technology, an emotion inference and representation technology and so on as main element technologies.

Furthermore, research has been conducted on each element technology of the emotion processing technology, and a part of the element technologies has been commercialized in various fields, for example, brain engineering, face recognition, biometric identification and so on. In an emotional application service development environment, however, the recognition, inference, and expression for emotions are individually defined and processed. Therefore, the development of emotional application services as well as emotion information exchange between the emotional application services is not smoothly performed.

In a service environment in which a plurality of devices essentially share emotional information through a network such as an emotional home, a common development environment for emotion management technology should precede the emotion exchange.

Furthermore, an emotional home application service development environment for standardized objects and contents and emotion management, which has an open application program interface (API), needs to be provided so that a variety of emotional home application services are actively developed in the same device environment.

### SUMMARY OF THE INVENTION

An embodiment of the present invention is directed to an apparatus and method for efficiently supporting emotional application service development by efficiently performing the exchange of emotion such as profile when developing an emotional application service.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for developing a user-oriented emotional home application service includes: an emotional information collection unit configured to sense a user and a user's surrounding environment through a sensor and collect one or more pieces of emotional information; an emotional home application service platform engine configured to extract contents suitable for the user based on the collected emotional information; and an application service development support unit configured to support various tools including a service modeling tool for developing an emotional home application service.

In accordance with another embodiment of the present invention, a method for developing a user-oriented emotional home application service includes: checking whether or not emotional information is recognized by a sensing device constructed suitably for an emotional home application service environment; when it is checked that the user's emotional information is recognized through the sensing device, collecting user's emotional information for each sensing device; converting the emotional information for each sensing attribute; checking validity and subscriber registration through the emotional information and user identification information; processing the emotional information for each user into an emotion processing form, and inferring an emotional state based on the currently-collected emotional information; generating and storing profile information for changing user's profile information according to the inferred emotional state; checking whether emotional information exchange among a plurality of emotional home application services for the profile information is required or not; checking whether an emotion control procedure is required or not, according to the emotion inference result; feeding back an emotion change result based on provided contents, and changing, storing, and managing emotional profile information; and performing another control according to a changed emotion.

### BRIEF DESCRIPTION OF THE DRAWINGS

FIG. 1 is a schematic view of an apparatus for developing a user-oriented emotional home application service in accordance with an embodiment of the present invention.

FIGS. 2A to 2C are a detailed configuration diagram of the apparatus for developing a user-oriented emotional home application service in accordance with the embodiment of the present invention.

FIG. 3 is a flow chart of a method for developing a user-oriented emotional home application service by using the apparatus for developing a user-oriented emotional home application service, which is illustrated in FIGS. 1 and 2.

FIG. 4 is a detailed flow chart of the emotion control procedure in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In accordance with the embodiments of the present invention, emotional information is collected by considering a variety of situations, an intelligence function, a profile creation, exchange, and management technology, and a contents recommendation method based on contents management and emotion are provided, and a service modeling tool is provided. Therefore, it is possible to easily support the emotional application service development for supporting functions required for the emotional application service development.

Here, an apparatus for developing a user-oriented emotional home application service in accordance with an embodiment of the present invention may select only functions required by a user depending on an emotional home service application based on an open API architecture and develop a new emotion home application service. Accordingly, the apparatus for developing a user-oriented emotional home application service may be used to efficiently perform the exchange of emotions such as profiles during the emotional application service development, which makes it possible to more efficiently perform the emotional application service development.

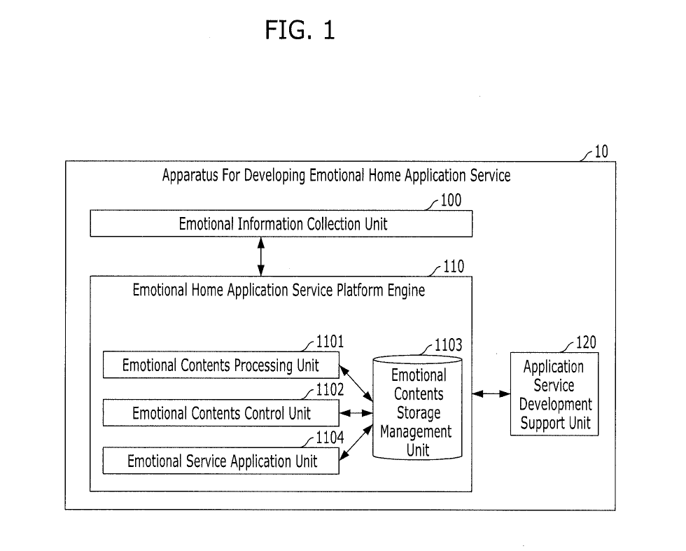

FIG. 1 is a schematic view of an apparatus for developing a user-oriented emotional home application service in accordance with an embodiment of the present invention.

Referring to FIG. 1, the apparatus 10 for developing a user-oriented emotional home application service includes an emotional information collection unit 100, an emotional home application service platform engine 110, and an application service development support unit 120.

The emotional information collection unit 100 is configured to collect one or more pieces of emotional and situational information through a user and a user's surrounding environment and generate emotional information to provide to an emotional contents processing unit 1101 of the application service platform engine 110.

The emotional home application platform engine 110 includes the emotional contents processing unit 1101, an emotional contents control unit 1102, an emotional contents storage management unit 1103, and an emotional service application unit 1104.

The emotional contents processing unit 1101 is configured to receive the emotional information generated by the emotional information collection unit 100, generate a user profile and metadata information based on the received emotional information, and store the generated user profile and metadata information in the emotional contents storage management unit 1103.

The emotional contents control unit 1102 is configured to exchange emotional information between emotional home application services based on the user profile information stored in the emotional contents storage management unit 1103, recommend contents suitable for the user, reconfigure contents information, and store the contents information in the emotional contents storage management unit 1103.

The emotion contents storage management unit 1103 is configured to store and manage the profile information, the metadata information, and the contents information.

The user profile information represents personal information of a user who uses an emotional home application service, and includes the user's emotional information, emotional sensing device information, emotional control device information, and situational information.

The metadata information includes a variety of information depending on emotion to extract contents suitable for an application service environment based on a user's emotional state. For example, the metadata information includes a contents name, a file format, a size, an update date, a creation date, a creator, the index information of contents and so on.

The contents information includes the contents extracted and reconfigured by the emotional contents control unit 1102.

The emotional service application unit 1104 is configured to request the emotional contents information from the emotional contents storage management unit 1103 and receive the emotional contents information, in order to output emotional contents through a device. Then, the emotional service application unit 1104 converts the received contents information according to the device setting, and outputs the converted information through the device.

The application service development support unit 120 is configured to support a variety of tools such as a service modeling tool for developing an emotional home application service.

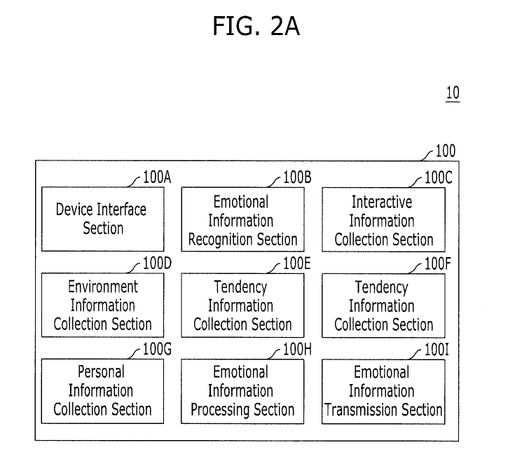

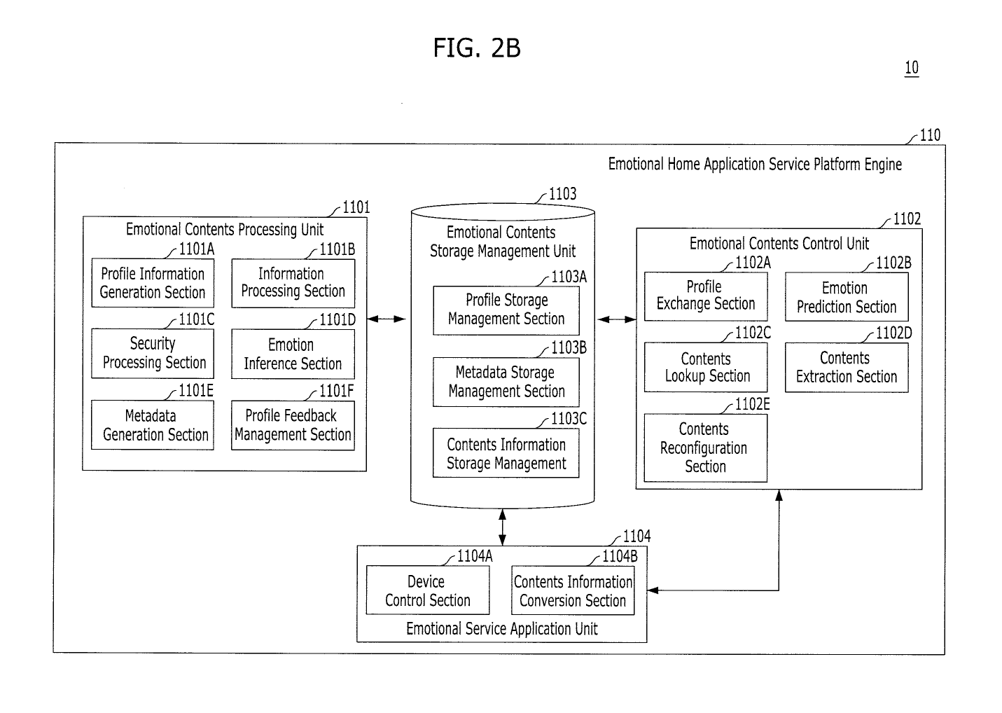

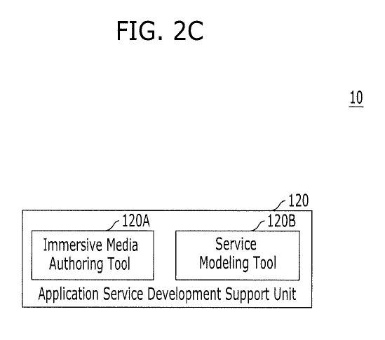

FIGS. 2A to 2C are a detailed configuration diagram of the apparatus for developing a user-oriented emotional home application service in accordance with the embodiment of the present invention.

Referring to FIGS. 2A to 2C, the emotional information collection unit 100 includes a device interface section 100a, an emotional information recognition section 110b, an interactive information collection section 100c, an environment information collection section 100d, a tendency information collection section 100e, a life pattern information collection section 100f, a personal information collection section 100g, an emotional information processing section 100h, and an emotional information transmission section 100i.

The device interface section 100a is configured to connect various sensing devices to collect the user's emotions.

The emotional information recognition section 100b is configured to recognize a variety of emotional information such as the user's voice, expression, motion, and body rhythm by using the various sensing devices connected through the device interface section 100a.

The interactive information collection section 100c is configured to collect information by segmenting emotions through the emotional information recognition section 100b. That is, the interactive information collection section 100c collects emotional states and emotional information for emotion feedback through a basic interactive interface.

The environment information collection unit 100d is configured to collect environment information through surrounding environment information such as illumination, humidity, temperature, and noise as well as the various sensing devices in a space where the user is positioned.

The tendency information collection section 100e is configured to recognize the user's personal current state of, for example, shopping, working, watching movies, taking a shower or the like, and collect the user's consumption tendency and preference.

The life pattern information collection section 100f is configured to recognize life patterns such as a user's rising, going-to-bed, going-out, or homecoming time, a dining time, and a home service utilization time and collects the user's life patterns.

The personal information collection section 100g is configured to collect user information containing basic personal information such as the user's ID, name, address, sex, age, hobby, occupation and so on.

The emotional information processing section 100h is configured to process the emotional information collected in a mobile environment excluding a home environment into a form suitable for the emotional home service platform engine 110.

The emotional information transmission section 100i is configured to transmit the emotional information processed by the emotional information processing section 100h to the emotional home application service platform engine 110.

As described above, the emotional home application service platform engine 110 includes the emotional contents processing unit 1101, the emotional contents control unit 1102, the emotion contents storage management unit 1103, and the emotional service application unit 1104.

The emotional contents processing unit 1101 includes a profile information generation section 1101a, an information processing section 1101b, a security processing section 1101c, an emotion inference section 1101d, a metadata generation section 1101e, and a profile feedback management section 1101f.

The profile information generation section 1101a is configured to receive user information and users' emotional information from the emotional information collection unit 100, generate profile information for each user based on the received information, and store the generated profile information in the emotional contents storage management unit 1103.

The profile information for each user include personal information, emotional information, sensing device information, emotion control device information, and situational information. Each information has attribute information for each object.

The personal information contains personal attribute information such as the ID, name, position, sex, and age of each user.

The emotional information which is used for managing a user's emotional state contains user's basic emotions, for example, personal emotion states such as joy, sadness, shock, satisfaction, dissatisfaction, astonishment, tiredness, depression, excitement, and calmness.

The sensing device information is information on a sensing device which belongs to each user and is used for collecting the user's emotional information. The sensing device may include a pupil recognition sensor, a voice sensor, an expression sensor, a surrounding environment sensor and so on.

The emotion control device information is information on a device which is used for controlling a user's personal emotion. The device may include surrounding devices required for controlling various emotions, such as a TV, a terminal, a DVD player, a lamp, a digital wall, and a sound portable device.

The situational information contains additional information required for recognizing a surrounding situation other than a user's emotion state to accurately device the user's emotion state. For example, the additional information includes information on user's personal life patterns such as going-to-bed, dining, shopping, working, watching movies, and taking a shower or a user's current state.

Furthermore, the situational information contains attribute information of a user ID for identifying a user, position information for discriminating internal and external environments, detailed position information, a situation recognition information type, situational information, and situation collection time information.

The information processing section 1101b is configured to process information required for emotion processing based on the environment information other than the emotion information and store the processed information in the emotional contents storage management section 1103.

The security processing section 1101c is configured to manage user's emotional information, and the emotion inference section 1102d is configured to recognize, infer, and analyze an emotion state based on the collected emotional information and store the emotion analysis result in the emotional contents storage management unit 1103.

The metadata generation section 1101e is configured to recommend various contents suitable for user's emotional information and manage contents and services for emotion control.

The profile feedback management section 1101f is configured to periodically request emotional information feedback from the emotional information collection unit 100 through an emotion control algorithm. When changed emotional information exists, the profile feedback management section 1101f receives the changed emotional information to store in the emotion contents storage management unit 1103.

The emotional contents control unit 1102 includes a profile exchange section 1102a, an emotion prediction section 1102b, a contents lookup section 1102c, a contents extraction section 1102d, and a contents reconfiguration section 1102e.

When receiving an exchange request message for exchanging emotional information with an emotional home application service from a plurality of emotional home application services, the profile exchange section 1102a converts emotional information corresponding to the exchange request message suitably for the corresponding device and exchanges the converted information.

The emotion prediction section 1102b is configured to predict current emotional information based on the user's emotional information. That is, the emotion prediction section 1102b decides whether or not to perform an emotion control procedure according to the emotion analysis result inferred by the emotion inference section 1101d of the emotional contents processing unit 1101. When deciding that the emotion control procedure is required, the emotion prediction section 1102b first analyzes the user's emotional information, predicts a current emotion state, and generate emotion prediction state information, in order to perform the emotion control procedure. On the other hand, when it is decided that the emotion control procedure is not required, the contents recommendation algorithm is ended.

The contents lookup section 1102c is configured to look up contents suitable for an emotional home application service in a contents information storage management section 1103b of the emotion contents storage management unit 1103 based on the profile information stored in the contents information storage management section 1103b of the emotion contents storage management unit 1103, and generate a contents list to transmit to the contents extraction section 1102d.

The contents extraction section 1102d is configured to extract contents suitable for the emotional home application service environment from the contents list transmitted from the contents lookup section 1102c through the emotion prediction state information transmitted from the emotion prediction section 1102b, and stores the extracted contents in a contents information providing management section 1103c of the emotion contents storage management unit 1103.

The contents reconfiguration section 1102e is configured to generate contents by mixing or reconfiguring the contents based on the contents extracted by the contents extraction section 1102d and store the generated contents in the contents information storage management section 1103c of the emotion contents storage management unit 1103.

The emotion contents storage management unit 1103 includes a profile storage management section 1103a, a metadata storage management section 1103b, and a contents information storage management section 1103c. The emotion contents storage management unit 1103 not only stores data depending on the type of the data, but also supports real-time search.

The profile storage management section 1103a is configured to store the profile information generated by the profile information generation section 1101a of the emotional contents processing unit 1101 and provide profile information when the profile exchange section 1102a of the emotional contents control unit 1102 requests a profile.

The metadata storage management section 1103b is configured to manage metadata. When the emotional contents control unit 1102 and the emotional service application unit 1104 request metadata information for performing a function of contents reconfiguration or the like, the metadata storage management section 1103b provides the metadata.

The contents information storage management section 1103c is configured to provide contents corresponding to profile information, when the contents lookup section 1102c requests the contents corresponding to the profile information, and storage and manage the contents extracted by the contents extraction section 1102d and the contents reconfigured by the contents reconfiguration section 1102e.

The emotional service application unit 1104 includes a device control section 1104a and a contents information conversion section 1104b.

The contents information conversion section 1104b is configured to reconfigure the contents extracted and reconfigured by the emotional contents control unit 1102 according to a device control service environment.

The device control section 1104a transfers the contents converted by the contents information conversion section 1104b to a user.

The application service development support unit 120 supports various tools such as a service modeling tool for developing an emotional home application service, and includes an immersive media authoring tool 120a and a service modeling tool 120b.

The immersive media authoring tool 120a is a tool for controlling emotional information by generating and editing contents.

The service modeling tool 120b is a tool for designing a business flow of an emotional hole application service and systematically supporting the application service development to positively utilize all APIs provided by the user-oriented emotional home application service development platform.

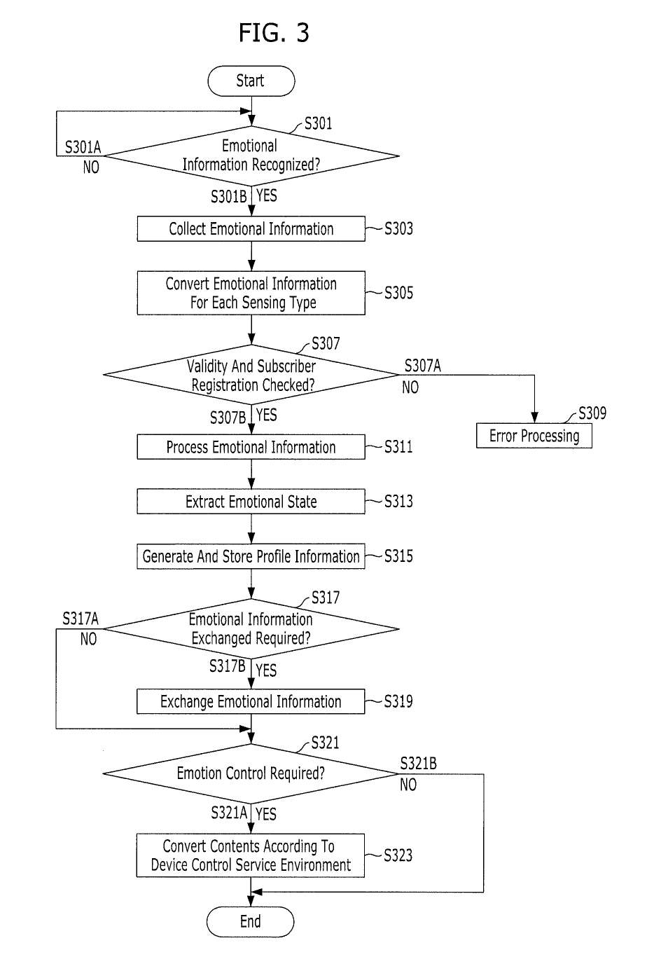

FIG. 3 is a flow chart of a method for developing a user-oriented emotional home application service by using the apparatus for developing a user-oriented emotional home application service, which is illustrated in FIGS. 1 and 2.

First, the emotional information collection unit 100 checks whether user's emotional information is recognized by each sensing device constructed suitably for an emotional home application service environment at step S301.

When it is checked that the user's emotional information is not recognized through the sensing device at step S301A, the service returns to the step S301 to recognize the user's emotional information.

On the other hand, when it is checked that the user's emotional information is recognized through the sensing device at step S301B, the user's emotional information is collected for each sensing device at step S303.

The emotional information collection unit 100 converts the user's emotional information into a processable form inside the emotional home service platform engine 110 according to a sensing type of the sensing device and transfers the converted emotional information and user identification information to the emotional home service application platform engine 110 at step S305.

The emotional home service application platform engine 110 checks validity and subscriber registration through the emotional information and the user identification information transmitted from the emotional information collection unit 100, at step S307.

When the subscriber registration information is not checked at step S307A, the emotional information and the user identification information are processed as an error, and the service is ended, at step S309.

On the other hand, when the subscriber registration information is checked at step S307B, the emotional home application service platform engine 110 processes the emotional information for each user into an emotion processing form at step S311, and infers an emotion state based the currently-collected emotional information at step S313.

According to the inference result, the emotional home application service platform engine 110 generates and stores profile information for changing user's profile information at step S315.

The emotional home application service platform engine 110 checks whether the exchange of emotional information between an emotional home application service and a plurality of emotional home application services is required or not at step S317.

When it is checked that the exchange of the emotional information is not required at step S317A, whether or not to perform an emotional control procedure is checked at step S321.

On the other hand, when it is checked that the exchange of the emotional information is required at step S317B, the emotional home application service platform engine 110 receives an emotional information exchange request message from the plurality of emotional home application services, extracts emotional information corresponding to the emotional information exchange request message, converts the extracted emotional information suitably for the corresponding device, and transmits the converted information at step S319.

Then, the service proceeds to the step S321 to check whether the emotion control procedure is required or not.

When it is checked that the emotion control procedure is required at step S321A, optimal contents are extracted through the emotional control procedure, converted suitably for the device control service environment, and then provided at step S323.

On the other hand, when it is checked that the emotion control procedure is not required at step S321B, the service is ended at step s325.

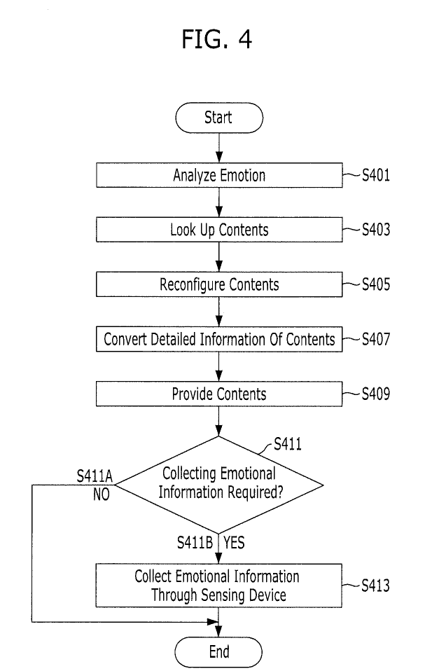

FIG. 4 is a detailed flow chart of the emotion control procedure in accordance with the embodiment of the present invention.

The emotional home application service platform engine 110 analyzes emotional information for emotion control based on the emotional information at step S401.

The emotional home application service platform engine 110 looks up contents required for emotion control at step S403, and reconfigures the contents at step S405.

Then, the emotional home application service platform engine 110 converts detailed information of the reconfigured contents suitably for the control device service environment at step S407, and then provides the contents through the corresponding device at step S409.

Whether the user's emotional information needs to be collected during the emotion control procedure or not is checked at step S411.

When the collection of the user's emotional information is not required at step S411A, the emotion control procedure is ended.

On the other hand, when the collection of the user's emotional information is required at step S411B, the service returns to the step S401 to check whether the emotional information is recognized or not, and the user's emotional information is collected through the corresponding device at step S413.

In accordance with the embodiments of the present invention, the functions related to emotion recognition, emotion exchange, inference, and representation, and control are utilized to easily develop an emotional home application service through the platform structure for developing a user-oriented emotional home application service. Furthermore, since the same development platform is used, the emotion exchange between the respective application services may be smoothly performed.

Furthermore, as the service modeling tool, the immersive media authoring tool, and so on are provided to efficiently support the emotional home application service development, it is possible to effectively perform emotion control through service modeling and a sensory effect. Furthermore, all the API of the platform for developing an emotional home application service may support an open API. Therefore, it is possible to more actively support the emotion home application service development. The various control functions considering a mobile environment are provided to thereby impart efficiency to the emotion application service development.

Meanwhile, the embodiments of the present invention may be written as a computer program. Furthermore, codes and code segments forming the computer program may be easily inferred by a computer programmer skilled in the art. Furthermore, the written program may be stored in a computer-readable recording medium (information storage medium), and a computer reads and executes the program to implement the method in accordance with the embodiment of the present invention. The recording medium includes all types of computer-readable recording media.

While the present invention has been described with respect to the specific embodiments, it will be apparent to those skilled in the art that various changes and modifications may be made without departing from the spirit and scope of the invention as defined in the following claims.

What is claimed is:

1. An apparatus for developing a user-oriented emotional home application service, comprising:
an emotional information collection unit configured to sense a user and a user's surrounding environment through a sensor and collect one or more pieces of emotional information;
an emotional home application service platform engine configured to extract contents suitable for the user based on the collected emotional information; and
an application service development support unit configured to support various tools including a service modeling tool for developing an emotional home application service.

2. The apparatus of claim 1, wherein the emotional home application service platform engine comprises:
an emotional contents processing unit configured to generate user profile and metadata information based on the emotional information collected by the emotional information collection unit;
an emotional contents control unit configured to exchange emotional information between emotional home application services based on the profile information generated by the emotional contents processing section, and recommend and reconfigure contents suitable for the user;
an emotional contents storage management unit configured to store and manage the profile information, the metadata information, and the contents information; and
an emotional service application unit configured to convert detailed information of the recommended contents according to detailed information of a device and output the converted contents through the device.

3. The apparatus of claim 1, wherein the application service development support unit comprises:
an immersive media authoring tool configured to control emotional information by generating and editing contents; and
a service modeling tool configured to design a business flow of an emotional home application service and systematically support application service development to utilize all application program interfaces (API) provided by an emotional home application service development platform.

4. The apparatus of claim 2, wherein the emotional contents processing unit comprises:
a profile information generation section configured to receive user information and emotional information from the emotional information collection unit and generate user profile information based on the user information and the emotional information;
an information processing section configured to process information required for emotion processing based on environmental information other than the emotional information;
a security processing section configured to manage the user's emotional information;
an emotion inference section configured to recognize, infer, and analyze an emotional state based on the emotional information;
a metadata generation section configured to recommend various contents suitable for the emotional information and manage contents and services for emotion control; and
a profile feedback management section configured to periodically request emotional information feedback from the emotional information collection unit through an emotion control algorithm and receive and manage changed emotional information when the changed emotional information exists.

5. The apparatus of claim 2, wherein the emotional contents control unit comprises:
a profile exchange section configured to exchange profiles among a plurality of emotional home application services;
an emotion prediction section configured to predict current emotional information based on the user's emotional information, in order to recommend contents and perform an emotion control algorithm;
a contents lookup section configured to look up contents suitable for an emotional home application service in the emotional contents storage management unit, based on the emotional information;
a contents extraction section configured to extract contents suitable for the emotional home application service environment from the contents looked-up by the contents lookup section through the emotional information predicted by the emotion prediction section; and
a contents reconfiguration section configured to reconfigure the contents based on the contents extracted by the contents extraction section.

6. The apparatus of claim 2, wherein the emotional contents storage management unit comprises:
a profile storage management section configured to store and manage the profile information;
a metadata storage management section configured to manage contents; and
a contents information storage management section configured to store and manage the contents information.

7. The apparatus of claim 2, wherein the emotional service application unit comprises:
a contents information conversion section configured to reconfigure the contents recommended by the emotional contents control unit according to a device control service environment and convert contents information according to a device; and
a device control section configured to transmit the contents converted by the contents information conversion section to the user.

8. A method for developing a user-oriented emotional home application service, comprising:
checking whether or not emotional information is recognized by a sensing device constructed suitably for an emotional home application service environment;
when it is checked that the user's emotional information is recognized through the sensing device, collecting user's emotional information for each sensing device;
converting the emotional information for each sensing attribute;
checking validity and subscriber registration through the emotional information and user identification information;
processing the emotional information for each user into an emotion processing form, and inferring an emotional state based on the currently-collected emotional information;
generating and storing profile information for changing user's profile information according to the inferred emotional state;
checking whether emotional information exchange among a plurality of emotional home application services for the profile information is required or not;
checking whether an emotion control procedure is required or not, according to the emotion inference result;
feeding back an emotion change result based on provided contents, and changing, storing, and managing emotional profile information; and
performing another control according to a changed emotion.

9. The method of claim 8, wherein, in said checking whether the emotional information exchange among the plurality of emotional home application services for the profile information is required or not, an emotional information exchange request message is received from the plurality of emotional home application service, and emotional information corresponding to the emotional information exchange request message is extracted, converted suitably for a corresponding device, and then transmitted.

10. The method of claim 8, wherein, in said checking whether the emotion control procedure is required or not according to the emotion inference result, when the emotion control procedure is required, optimal contents are extracted through the emotion control procedure, converted suitably for a device control service environment, and then provided.

11. The method of claim 10, wherein the emotion control procedure comprises:
analyzing emotional information for emotion control based on the emotional information;
looking up contents required for emotion control and reconfiguring the contents;
converting detailed information of the reconfigured contents according to a control device environment, and the providing the contents through the corresponding device; and
checking whether or not to collect user's emotional information, and recollecting the user's emotional information through a sensing device when it is checked that the collection of the user's emotional information is required.
